(19) United States
(12) Patent Application Publication
(10) Pub. No.: US 2023/0017472 A1
(43) Pub. Date: Jan. 19, 2023

(54) DEVICE COMPRISING AN RFID TAG WHICH CAN BE USED AT LEAST IN A MICROWAVE OVEN, AND RECEPTACLE OR PACKAGING PROVIDED WITH AT LEAST ONE SUCH DEVICE

(71) Applicant: YESITIS, Clermont Ferrand (FR)

(72) Inventor: GHJUVAN-BATTISTI PANTALONI, UCCIANI (FR)

(21) Appl. No.: 17/860,379

(22) Filed: Jul. 8, 2022

(30) Foreign Application Priority Data
Jul. 10, 2021 (FR) 2107527

(51) Int. Cl. G06K 19/077

(52) U.S. Cl. CPC G06K 19/07771; G06K 2019/06253

(57) ABSTRACT

The invention is a device (E) with an RFID tag ( ), with the tag (1) is provided on one (12) of the faces (12, 13) with a layer (14, 14A) of a protective material, where the material being based on silicone and having a dielectric permittivity of greater than at least three times the dielectric permittivity of the air, and in that the layer (14, 14A) of material has a thickness of at least 6 millimeters. The invention also relates to a receptacle or packaging provided with a device of this kind.

The present invention relates to a device comprising an RFID tag which can be used at least in a microwave oven. The invention also relates to a receptacle or packaging provided with at least one such device.

An RFID tag (Radio Frequency Identification) is a device for remote storing and transmitting data by means of radio waves, at a defined frequency. The data are stored on an electronic chip which is fixed to a carrier, generally having a small thickness, which also comprises an antenna which allows for data exchange between the electronic chip and a dedicated remote reader. The RFID tags are of dimensions such that they can be fixed or incorporated in a number of objects or products, thus ensuring the identification, the tracking, and/or the provision of complementary information relating thereto. On account of their ease of implantation and their dimensions, the RFID tags are present on various objects or products which may be found in restrictive environments or those which may damage the RFID tag.

### DESCRIPTION OF THE RELATED ART

In particular, the RFID tags present on the packaging or receptacles for food or other products may have to withstand microwaves emitted by a microwave oven, in the event of defrosting, cooking or reheating of the product contained in the packaging or the receptacle. In such a case, the RFID tags are also subjected to high temperatures, typically of over 50° C. In order to preserve the properties and the functioning of the RFID tag, and thus ensure the storage and the transmission of data between the RFID tag and the reader, it is expedient for the RFID tag not to be, or to be only slightly, affected by the microwaves emitted by a microwave oven. For the record, microwaves are electromagnetic waves which are located between radioelectric waves and infrared radiation. Typically in the case of a microwave oven, their wavelengths are 12.5 cm and their frequencies are 2.45 GHz, for microwave oven powers that are generally between 600 W and 2000 W, typically encountered for apparatuses for domestic use. In the case of a microwave oven, a high-power electromagnetic field is generated, which destructs the RFID tags whatever the frequency band of the RFID tags. In order to overcome this, various solutions are known for shielding the RFID tag, in the region of the electronic chip and/or in the region of the antenna. Of the known solutions, EP-A-3 563 299 can be cited, which describes a shielding solution on the electronic chip, it being possible that the antenna may fracture when the temperature increases. U.S. Pat. No. 10,311,355 discloses capacitive shielding for the antenna, the shielding making it possible to evacuate the energy received by the antenna in the form of heat. US-A-2008 143 480 describes a particular shape (polygonal) of the antenna which provides the antenna with a surface area of less than ⅙th of the wavelength of the microwave oven. WO-A-2021 079 265 discloses shielding on a side of the carrier bearing the RFID tag, in order to limit the voltage in the space defined by the antenna. The solution provided by WO-A-2021 072 966 consists in a two-part antenna, between which parts a bridge having low impedance for the microwaves is defined. EP-A-3 136 298 relates to an RFID tag comprising a silicone-based upper and lower protective layer. WO-A-2009/119828 relates to a contactless transceiver, and thus it also relates to an RFID tag, comprising silicone as a protective element, in particular against heat. US-A-2012/298758 describes a method for implanting objects, i.e. RFID tags, into objects containing metal. The RFID tags are encapsulated in a heat-resistant coating which may comprise silicone. KR-B-101 508 765 discloses an RFID tag which is provided with a shielding layer formed by a metal layer and a layer of heat-resistant resin. These various solutions are more or less complex to implement.

The invention proposes a solution which makes it possible, in a simple manner and at a low cost, to protect the entirety of the RFID tag, i.e. the antenna and the electronic chip, in order to make the tag usable at least in microwave oven.

### BRIEF SUMMARY OF THE INVENTION

For this purpose, the invention relates to a device comprising an RFID tag comprising an antenna and an RFID chip which are fixed to a planar support, said tag comprising, on at least one of the faces thereof, a layer of a protective material covering the antenna and the electronic chip, said material being based on silicone and having a dielectric permittivity of greater than at least three times the dielectric permittivity of air, and said layer of material having a thickness of at least 6 millimeters, characterized in that the RFID tag is provided on one face with a layer of silicone-based material, and on the opposite face with a layer of a material selected from a layer of a silicone-based material or a layer of an electrically conductive metal material having a thickness of at least three times the penetration depth of microwaves at 2.45 GHz into the metal material.

The dielectric permittivity of the silicone, which is the main component of the material, and thus the response of the silicone to an electric field, is of the order of four, i.e. a material that is more electrically insulating than air which is generally the initial propagation medium of microwaves, in particular in a microwave oven. Thus, a change of medium between the air and the silicone-based material takes place which is all the more significant because, at the minimum thickness selected, microwaves having the frequency commonly encountered in a microwave oven, in the region of 2.45 GHz, do not or only slightly reach the RFID tag, while allowing the RFID tag to remain functional at the operating frequency of the RFID tag, which is in the region of 868 MHz. Using food-grade silicone makes it possible to incorporate the RFID tag, thus protected, in a receptacle or packaging receiving a food product.

According to advantageous but non-essential aspects of the invention, a device of this kind may comprise one or more of the following features:

The two faces of the RFID tag comprise a silicone-based material which is rigidly connected to said faces and has a thickness of at least 6 millimeters.

The silicone-based material is formed of food-grade silicone.

The silicone-based material has a permittivity of 4.

The metal material is copper formed as a thin plate.

The material is aluminum formed as a thin plate.

The plate of metal material has a thickness of ten times the penetration depth of microwaves at 2.45 GHz into the metal material.

The layer of metal material is rigidly connected to the face of the planar support of the RFID tag which defines the face of the device that is intended to be in contact with a receptacle or packaging.

The invention also relates to a receptacle or packaging provided with at least one device according to any of the preceding features.

According to advantageous but non-essential aspects of the invention, a receptacle or packaging of this kind may comprise one or more of the following features:

At least one device comprising an RFID tag provided on one face with a layer of silicone-based material, and on the opposite face with a layer of a material selected from a layer of a silicone-based material or a layer of an electrically conductive metal material having a thickness of at least three times the penetration depth of microwaves at 2.45 GHz into the metal material, is positioned on a wall of the receptacle or of the packaging that is oriented according to the height of the receptacle or of the packaging.

### BRIEF DESCRIPTION OF THE SEVERAL VIEWS OF THE DRAWINGS

The invention will be better understood, and further advantages thereof will become clear from reading the following description, given merely by way of non-limiting example and with reference to the accompanying drawings, in which:

FIG. 1 is a simplified plan view of an RFID tag according to an embodiment of the invention,

FIG. 2 is a simplified perspective and partially exploded view, to a different scale, of a microwave oven and the constituent parts thereof,

FIG. 3 is a side view, to a different scale, of an RFID tag according to an embodiment of the invention, and

FIG. 4 is a side view, to a different scale, of an RFID tag according to another embodiment of the invention.

### DETAILED DESCRIPTION OF THE INVENTION

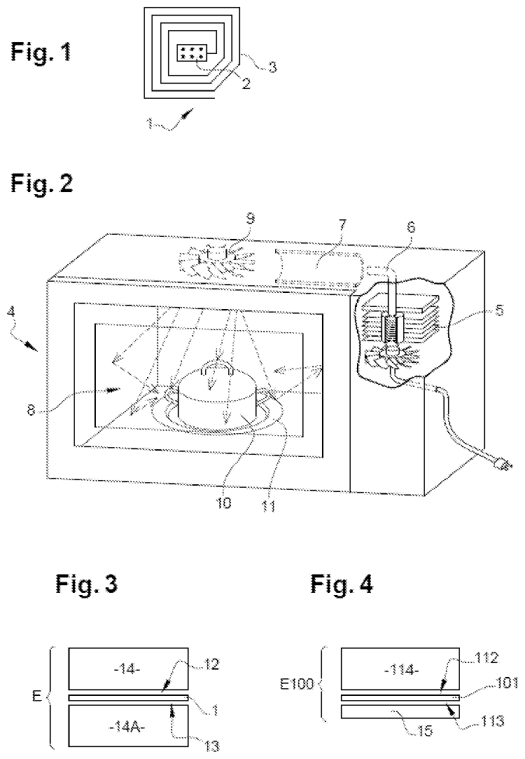

FIG. 1 shows, in a simplified manner, an RFID tag 1 as typically encountered. A tag 1 of this kind comprises an electronic chip 2 on which information is stored that relates to the product or to the object which will be associated with the tag 1. The chip 2 also comprises communication means for communicating with a remote reader. The transmission of the information between the tag 1 and the reader (not shown, for the purpose of improved legibility) takes place by means of terrestrial radio reception, via an antenna 3. The antenna 3 is formed by a wire element of the dipole type which is fixed, by one end, to the chip 2. In a variant, the antenna is formed so as to be helical. The elements 2 and 3 which make up the tag 1 are of a low thickness and advantageously fixed to a planar support, of the leaf type, and are inert with respect to the chip 2 or to the antenna 3. Thus, a tag 1 has dimensions, in particular the thickness thereof, that allow for it to be assembled, in a discrete manner, on the products or objects, without substantially modifying the nominal dimensions of the product or of the object. By way of example, an RFID tag is generally rectangular in shape, from 15 to 25 mm wide and 30 to 80 mm long, the thickness thereof being between 0.5 mm and 1.5 mm.

A tag 1 is intended, for example, for equipping packaging or a receptacle which is capable of being in contact with food. The feature of an object being “in contact with food” means that the material of which it is made meets the regulatory and/or normative requirements which guarantee that there is no risk of toxicity with respect to a human or an animal, brought about by the object for foods, drinks, medications, or other products which may be ingested by a living being and which are in contact with the object, under normal use conditions of the object. When the packaging or the receptacle provided with the tag 1 contains prepared foods or ready meals, the user often defrosts, re-heats, or finishes the cooking of the prepared foods or of the ready meals. In addition to the possibility of removing the foods or meals from the packaging or from the receptacle, the user also has the possibility of placing the receptacle or packaging directly into a heating appliance, provided that the packaging or the receptacle are suitable for a use of this kind. In this case, the packaging or the receptacle is based on cardboard, baking parchment, wax paper, plastics material, wood, or the like, depending on the cooking appliance, which may be either a cooking oven or, generally and preferably, a microwave oven.

When the defrosting, the cooking or the reheating is carried out in a microwave oven, this involves certain restrictions on account of the operation of this type of oven. In a microwave oven such as the oven 4 shown schematically in FIG. 2, a magnetron 5 formed of a plurality of magnetic blades produces a magnetic field having a very high frequency, i.e. 2.450 GHz. An antenna 6 collects the magnetic field emitted by the magnetron 5 and directs it towards a waveguide 7. The waves are sent into the useful volume 8 of the oven 4 by means of a wave cross-connect 9 which ensures the dispersion of the waves in the volume 8. The metal walls defining the volume 8 are metal and return, by means of rebound, the waves towards the interior of the volume 8. During their passage in the volume 8, the microwaves pass through most of the non-metal receptacles and packaging, represented here by the receptacle 10, and the food or products which they contain. Since water is the main constituent of food, and more generally of any product of biological origin, the microwaves force the water molecules to orient themselves in the direction of the rotating electric field. The water molecules thus oscillate at the frequency of the magnetic field, i.e. 2.45 GHz, said oscillation produces heat. In order to uniformly distribute the heat in the receptacle 10, this is placed on a turntable 11. The speed of heating of the foods is determined by the electric power of the microwave oven 4. For ovens 4 for domestic use, the powers are generally between 700 W and 1200 W.

In all cases, whatever the power of the oven 4, the electromagnetic field is of a power such that it generates high-intensity electric currents in the presence of conductive materials, such as those making up an RFID tag 1. These intense electric currents, other than heating the materials which make up the tag 1, give rise to electric arcs due to the point effect, in the region of the angular conductive parts of the RFID tag 1, which leads to rapid destruction thereof.

In addition to resistance to microwaves during passage in the over 4, an RFID tag 1 must also be able to operate at the UHF frequencies often used, i.e. between 860 MHz and 930 MHz, during the passage thereof in the oven 4 as well as after, once the receptacle 10 has left the oven 4. The solution implemented by the invention is shown schematically in FIGS. 3 and 4.

This solution brings about a change in the microwave propagation medium, which has the effect of modifying the microwave propagation speed, but without changing the frequency. However, the higher the frequency of a wave, the smaller the penetration depth of the wave into the material will be. By way of example, in a microwave oven, there is penetration over a depth of approximately 0.5 cm to 2 cm for non-frozen meat-based, fruit-based or vegetable-based products, and over a depth which can be up to 30 cm for products which are frozen, thus containing more water.

As is clear from FIGS. 3 and 4, the RFID tag 1 comprises a silicone-based material on at least one of the faces 12 or 13 thereof.

According to the embodiment of the device E of FIG. 3, each layer 14, 14A is rigidly connected to each face 12, 13, respectively, of the RFID tag 1, over the entire surface area of each face 12, 13, in order to completely cover the RFID tag 1 when each layer 14, 14A is in place. For ease of reading, in this case the layers 14, 14A are represented as not being fixed to the faces 12, 13 of the RFID tag 1.

The silicone-based material which makes up each layer 14, 14A is, according to an advantageous embodiment, food-grade silicone. The silicones, or polysiloxanes, are inorganic compounds formed of a silicon/oxygen chain, in which groups bind to the silicon atoms. The designation “food-grade silicone” refers to a silicone elastomer, which is generally two-component and cross-linked by means of ambient temperature or hot vulcanization. A food-grade silicone is thus resistant to high temperatures, while preventing the migration of particles into the food. All food-grade silicones must comply with the standards and/or regulations in force with respect to products in contact with food. The food-grade silicone is provided in liquid or solid form, in which case it has an increased level of malleability, of the rubber type. It is thus easy to shape it and to fix it on a carrier, by means of techniques that are known per se, such as adhesive bonding.

In all cases, the silicone-based material used must have a permittivity greater than that of the initial propagation medium of the microwaves in a microwave oven 4. “Initial” denotes the medium through which the microwaves pass first, once dispersed by the wave cross-connect 9 and before penetrating into the receptacle 10. It is therefore the volume of air present in the volume 8 of the microwave oven 4. A dielectric material or medium, such as air, is a material or medium which cannot conduct the electric current. Nonetheless, the behavior of a dielectric in the presence of an electric field is very variable. Indeed, the atoms making up the material or the medium may interact with an external electric field. Said interaction induces a polarization of the material or of the medium connected to the external electric field, and thus an orientation of the atoms which make up the material or the medium, under the action of the electric field. The permittivity, more precisely the dielectric permittivity, is the physical property which describes the way in which the electric field influences the organization of the electric charges in a given material or medium. The permittivity is adimensional when it is the relative or constant dielectric permittivity, with respect to the permittivity of the vacuum which is defined as being 1.

The permittivity of air is very close to that of the vacuum and, by extension, also considered to be equal to 1. Consequently, the permittivity of the initial propagation medium is thus considered to be equal to 1. The silicones used in the invention have a permittivity close to 4, generally between 3.2 and 4.7, depending on the composition of the silicones. Their behavior is thus very different from that of air, in the presence of microwaves, and also different from that of food or products placed in the receptacle 10 for the purpose of heating or cooking. Insofar as this food and these products comprise mainly water, they are better conductors than air and silicone. Thus, a significant change of medium takes place between the food or products and the silicone, which generates reflection and diffraction of the microwaves. The change of medium is generally accompanied by heat emission by Joule effect, i.e. by heating of the material during the passage of the microwaves. As a result, the quantity of microwaves capable of crossing the silicone-based layers 14, 14A, as well as the quantity of heat received by the silicone-based material, is reduced.

Furthermore, a minimum thickness to be respected for each layer 14, 14A limits the penetration depth of the microwaves into the layers 14, 14A, which makes it possible to further limit the sensitivity of the RFID tag 1 to microwaves. It has been determined that a minimum thickness of 6 mm of each layer 14, 14A of silicone-based material fixed on the faces 12, 13 of the tag 1 makes it possible to make said tag virtually invisible to microwaves at the frequency of 2.45 GHz without significantly affecting the RFID tag 1 which remains functional at the use frequency thereof, i.e. in this case 868 MHz. By associating a minimum thickness of each layer 14, 14A of material having a permittivity so as to generate a change of the microwave propagation medium, a device E is formed which optimizes the protection of the RFID tag 1 from microwaves, without significantly modifying the nominal dimensions of the tag 1 or the ability of the device E to be fixed to and/or integrated in a receptacle 10. The thickness of the device E formed of an RFID tag 1 provided on the two faces 12, 13 thereof with a layer 14, 14A of silicone-based material is thus between 13 mm and 15 mm. According to the embodiment shown in FIG. 3, the layers 14, 14A fixed to the faces 12 and 13 of the RFID tag 1 are identical, in composition and in thickness. In a variant that is not shown, the layers 14, 14A fixed to the faces 12 and 13 are different, in thickness and/or in composition. Thus, the material layer 14 is adjusted to the carrier of the electronic chip 2 and of the antenna 3, and/or to a part of the receptacle 10 on which the device E is fixed and/or in which it is integrated.

Tests have been performed using an RFID tag 1 which complies with the international standards EPC global Class 1 Gen 2 ISO 18000-6C, such as that marketed by the company NXP under the designation Ucode 8. In the case of a rectangular tag 1 of this kind, the electronic chip 2 measures 48 mm by 22 mm for 70 μm thickness, the antenna 3 measuring 42 mm by 16 mm. The overall nominal dimensions of the RFID tag 1 are 50 mm by 22 mm for a thickness close to that of the electronic chip 2. Once provided with the two layers of material 14, 14A, the device E measures 60 mm by 27 mm for a thickness of 12.07 mm, i.e. a thickness close to the cumulative thicknesses of the layers 14, 14A of silicone. The device E has been fixed to receptacles 10 of different kinds but which are often used for cooking or reheating food in the microwave oven, in this case a cylindrical glass jar and a rectangular plastics box. Tests using a rectangular glass receptacle were also carried out. The receptacles 10 were simultaneously placed on the turntable 11 of the microwave oven 4 operating at a power of 850 W.

It has been found that the resistance of the device E to the microwaves is independent of the type of receptacle 10 and/or of the shape thereof, the behaviors being identical for the plastics box and for the glass jar or box. In contrast, the applicant has found that the position of the device E on the receptacle 10 affects the resistance of the RFID tag 1 to microwaves. In particular, when the device E is fixed to a vertical wall or to a largely vertical wall, i.e. a wall oriented according to the height of the receptacle 10, the RFID tag 1 remains functional, even in the case of superficial degradation, for more than 10 minutes in the microwave oven 4 during a unit test, and for more than 30 minutes cumulatively over a plurality of tests. However, when the device E is positioned on a horizontal or largely horizontal wall, i.e. a wall oriented according to the zone of contact of the receptacle 10 on the plate 11, the RFID tag 1 remains functional for less time, i.e. for more than 3 minutes cumulatively during tests in the oven 4. It therefore appears that there is greater sensitivity to microwaves when these arrive on the layers 14, 14A of material according to a direction close to 90° and/or when the device E is closest to the wave cross-connect 9, and thus closest to the microwave source. Thus, in the vicinity of the cross-connect 9, the dispersion of microwaves is low and the intensity of the microwaves is high.

Tests carried out using a device E of which the layers 14 and 14A fixed to the RFID tag 1 were of different thicknesses, respectively 4 mm for the layer 14 and 1 mm for the layer 14A, on the faces 12, 13, gave results identical to those described above when the device E is in place on a wall defining the height of the receptacle 10, i.e. being kept in the oven 4 for more than 10 minutes, and more than 30 minutes cumulatively. A device E of this kind, having different thicknesses of the layers 14, 14A exhibited a resistance of the RFID tag 1 of one minute when it is positioned on a wall oriented according to the zone of contact of the receptacle 10 on the plate 11.

Tests using devices E comprising, for one of the layers 14, 14A, silicones of identical thicknesses, i.e. 6 mm, and for the other different thicknesses, i.e. 4 mm and 1 mm, were also carried out in order to identify the resistance of the RFID tag 1 to heat, independently of the resistance to microwaves, i.e. tests in a “traditional” cooking oven. As for the tests above, the RFID tags 1 were positioned on receptacles 10 identical to those used for the tests in the microwave oven 4. The RFID tags 1 of the devices E resisted for 20 minutes, then 30 minutes in an oven at 207° C., having a temperature rise time of 10 minutes, given that the devices E were already present in the oven during the temperature rise. Surprisingly, the applicant has noted that the RFID tags 1, whatever the thicknesses of the silicone layers 14, 14A, cease to function, i.e. to receive and transmit data, when their temperature reaches 80° C., the RFID tag 1 moreover not being degraded. The RFID tags 1 function, i.e. receive and transmit, again when their temperature returns to below 80° C., whatever the thicknesses of the layers 14, 14A.

It therefore appears that a minimum thickness of 6 mm of silicone-based material having a dielectric permittivity of more than at least three times the dielectric permittivity of air, fixed to each face 12, 13 of the RFID tag 1, ensures optimum protection, for several minutes, or indeed tens of minutes if the device E formed by the RFID tag 1 comprising the layers 14, 14A of material is positioned on a wall of a receptacle defining the height thereof. This protection relates as much to the effect of the microwaves as to the effect of the heat on the RFID tag 1. It is therefore possible to provide receptacles or packaging able to be subjected to microwaves in a microwave oven or able to be heated in a traditional cooking oven, with a device E according to the invention. A receptacle or packaging thus equipped can be used in a microwave oven 4 or a traditional cooking oven, without this having any notable and lasting effect on the functioning of the RFID tag 1.

FIG. 4 shows another embodiment of the invention. For ease of reading, the elements in common with those of FIG. 3 have the same reference signs, increased by 100. In this case, the RFID tag 101 is provided with a layer 114 of silicone-based material, of a thickness of 6 mm, positioned on the face 112 of the RFID tag 101. The opposite face 113 is provided with a layer of a metal conductor 15, for example of copper or a copper-based alloy, or aluminum or an aluminum-based alloy. The metal conductor 15 makes it possible to reduce the electric generated by the RFID tag 101, more particularly the antenna when this is exposed to microwaves of a high frequency of 2.45 GHz emitted by a microwave oven 4. This is obtained by fringe effect or skin effect. This is an electromagnetic phenomenon which has the result that, at a higher frequency, the current tends to flow only at the surface of the conductors. This results in an increase in the resistance of the conductor. The current thus generated at the surface of the metal conductor layer 15 opposes the current generated by the antenna of the RFID tag 101, and thus an attenuation of the effect of the microwaves on the RFID tag 101 is obtained de facto.

In this embodiment, the layer 114 of silicone defines the upper layer of the device E100, the metal conductor layer 15 being opposite the surface of the receptacle 10 on which the device E100 is fixed. The metal layer, i.e. in this case copper or aluminum, has a thickness of at least three times the penetration depth of microwaves at 2.45 GHz into the metal material, and it is rigidly connected to the face of the planar support of the tag 101 which defines the face of the device E100 that is intended to be in contact with a receptacle or packaging. The plate of metal material, i.e. in this case copper or aluminum, advantageously has a thickness of ten times the penetration depth of microwaves at 2.45 GHz into the metal material. In the example, when the metal material is copper or aluminum, the thickness of the layer 15 is approximately 16 μm, the penetration depth of microwaves at 2.45 GHz being, respectively, 1.36 μm and 1.66 μm. In other words, the layer 15 forms the fixing means of the device E100 on a receptacle 10 or packaging. In this embodiment, the device E100 associates a change in the microwave propagation medium with electromagnetic shielding which reduces the electric current generated by the RFID tag 101 exposed to the microwaves.

Tests carried out by placing a device E100, fixed to receptacles identical to those used for the tests using the device E, in a microwave oven 4 of a power of 850 W, have shown that the RFID tag 101 remains functional for more than 10 minutes and, cumulatively over a plurality of tests, more than 30 minutes, whatever the zone of the receptacle 10 on which the device E100 is positioned.

In other words, a solution of this kind is independent of the position of the device E100 on the receptacle 10, in contrast with the solution based solely on a change of medium.

Performance tests in a conventional oven have also been performed using receptacles provided with the device E100, under conditions similar to those of the tests using the device E. The results obtained are similar, i.e. ceasing of functioning of the chip 2 above 80° C. and return to normal below 80° C.

Another solution which is considered but not illustrated consists in using a waveguide mounted instead of the antenna 3 and of the metal conductor layer 15. The assembly is overmolded or arranged on a silicone layer. In order to comply with the regulations relating to products in contact with food, it is preferable for the waveguide to be overmolded. In this case, the thickness of the silicone layer may be reduced to approximately one third of the thickness of the layer in the device E.

The waveguide makes it possible to separate the wave into two and to ensure that, at the frequency of 2.45 GHz, when the two waves meet at the output of the waveguide they are in phase opposition and thus cancel each other out. A test using waveguides in the place of an RFID tag has demonstrated a division by 100 of the power received by the RFID tag at 2.45 GHz.

Nonetheless, during a test in a microwave oven 4 at 850 W, the RFID tag remained functional for only 20 seconds, whether this be when the device is fixed to a glass receptacle or a plastics receptacle. Indeed, the power is increased to such an extent, and thus the intensity of the electric field is increased to such an extent, that the breakdown voltage of the electronic chip, which is part of the RFID tag, is quickly reached. Moreover, the temperature reached by the RFID tag at the end of 20 seconds is close to 50° C. In other words, the RFID tag heats up very quickly, the surface electric currents being intense. Electric arcs are furthermore formed during the tests in the microwave oven.

It therefore follows that the solution described in FIGS. 3 and 4, making use of at least one change in the propagation medium with at least one layer 14, 14A; 114 of silicone-based material, if necessary associated with an electromagnetic shielding by skin effect by virtue of a layer of metal material 15, is that which offers an optimum compromise among cost, implementation and effectiveness.

Thus, by virtue of the invention, it is possible to provide receptacles 10 and packaging, which are to undergo at least one passage in a microwave oven 4 or indeed in a conventional cooking oven, with at least one device E or E100 comprising an RFID tag 1 or 101 which makes it possible to exchange data relating to the packaging or to the receptacle, and/or the content thereof. When the receptacle 10 or the packaging is provided with a plurality of devices E and/or E100, at least one of which is a device E, having two layers 12, 13 of silicone-based material, then the device E is positioned on a wall of the receptacle or of the packaging which is oriented according to the height of the receptacle or of the packaging, in order to limit orthogonal arrival of microwaves onto the device.

The invention is thus applicable in the field of home catering, the field of collective catering, whether in a healthcare, care or holiday establishment, in the field of school or professional canteen catering, in airline, railway or shipping catering. The invention is also applicable in the pharmaceutical, chemical and food-processing fields.

1. A device (E; E100) comprising an RFID tag (1; 101) comprising an antenna (2) and an RFID chip (3) which are fixed to a planar support, said tag (1; 101) comprising, on at least one (12; 112) of the faces (12, 13; 112, 113) thereof, a layer (14, 14A; 114) of a protective material covering the antenna (3) and the electronic chip (2), said material being based on silicone and having a dielectric permittivity of greater than at least three times the dielectric permittivity of air, and said layer (14, 14A; 114) of material having a thickness of at least 6 millimeters, characterized in that the RFID tag (1; 101) is provided on one face (112) with a layer (114) of silicone-based material, and on the opposite face (113) with a layer of a material selected from a layer of a silicone-based material or a layer (15) of an electrically conductive metal material having a thickness of at least three times the penetration depth of microwaves at 2.45 GHz into the metal material.

2. The device according to claim 1, characterized in that the two faces (12, 13) of the RFID tag (1) comprise a silicone-based material which is rigidly connected to said faces (12, 13) and has a thickness of at least 6 millimeters.

3. The device according to claim 1, characterized in that the silicone-based material is formed of food-grade silicone.

4. The device according to claim 1, characterized in that the silicone-based material has a permittivity of 4.

5. The device according to claim 1, characterized in that the metal material is copper formed as a thin plate (15).

6. The device according to claim 1, characterized in that the material is aluminum formed as a thin plate.

7. The device according to claim 1, characterized in that the plate (15) of metal material has a thickness of ten times the penetration depth of microwaves at 2.45 GHz into the metal material.

8. The device according to claim 1, characterized in that the layer (15) of metal material is rigidly connected to the face of the planar support of the RFID tag (101) which defines the face of the device (E100) that is intended to be in contact with a receptacle (10) or packaging.

9. A receptacle (10) or packaging provided with at least one device (E; E100) according to claim 1.

10. The receptacle (10) or packaging according to claim 9, comprising an RFID tag (1; 101) provided on one face (112) with a layer (114) of silicone-based material, and on the opposite face (113) with a layer of a material selected from a layer of a silicone-based material or a layer (15) of an electrically conductive metal material having a thickness of at least three times the penetration depth of microwaves at 2.45 GHz into the metal material, is positioned on a wall of the receptacle or of the packaging that is oriented according to the height of the receptacle or of the packaging.
